(19) United States
(12) Patent Application Publication
(10) Pub. No.: US 2014/0292659 A1
(43) Pub. Date: Oct. 2, 2014

(54) ZERO-VOLUME TRACKPAD

(71) Applicant: Roy Stedman, Austin, TX (US)

(72) Inventor: Roy Stedman, Austin, TX (US)

(21) Appl. No.: 13/851,689

(22) Filed: Mar. 27, 2013

(51) Int. Cl. G06F 3/02

(52) U.S. Cl. CPC G06F 3/0202
USPC 345/168

(57) ABSTRACT

A method of determining user input into an information handling system includes determining a region of a zero-volume trackpad overlaying a keyboard area, detecting an access of the zero-volume trackpad, and determining whether to interpret the access as input into the zero-volume trackpad based upon timing of the input.

### TECHNICAL FIELD

This disclosure relates generally to information handling systems and more particularly to information handling systems including zero-volume trackpads.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. For example, an information handling system may be a tablet computer or mobile device (e.g., personal digital assistant (PDA) or smart phone) configured to transmit data on a wireless communications network. Information handling systems may include a variety of hardware and software components that may be configured to process, store, and communicate information and may include one or more computer systems, data storage systems, and networking systems.

As space constraints increase, there is pressure to increase the density of information handling systems by housing a greater number of nodes in an information handling system chassis. In an information handling system configured to house rack servers, it is not uncommon for a system board, power supply and other physical components to be associated with each node. To increase the density of an information handling system, however, the information handling system may be configured such to share physical components, such as a system board, a power supply, and/or fans.

### SUMMARY

In one embodiment of the present disclosure, a method of determining user input into an information handling system includes determining a region of a zero-volume trackpad overlaying a keyboard area, detecting an access of the zero-volume trackpad, and determining whether to interpret the access as input into the zero-volume trackpad based upon timing of the input.

In another embodiment of the present disclosure, an information handling system includes a sensor array configured to detect an access to a zero-volume trackpad and an input module communicatively coupled to the sensor array. The zero-volume trackpad overlays a keyboard area. The input module is configured to determine whether to interpret the access as input into the zero-volume trackpad based upon timing of the input.

In yet another embodiment of the present disclosure, a non-transitory computer-readable medium including computer-executable instructions encoded in the computer-readable medium is disclosed. The instructions, when executed by a processor, are operable to perform operations including determining a region of a zero-volume trackpad overlaying a keyboard area, detecting an access of the zero-volume trackpad, and determining whether to interpret the access as input into the zero-volume trackpad based upon timing of the input.

### BRIEF DESCRIPTION OF THE DRAWINGS

A more complete understanding of the disclosed embodiments and advantages thereof may be acquired by referring to the following description taken in conjunction with the accompanying drawings, in which like reference numbers indicate like features, and wherein:

FIG. 1 illustrates an example embodiment of an information handling system including a zero-volume trackpad;

FIG. 2 illustrates example operation of a trackpad as interpreted by an input module;

FIG. 3 illustrates additional example operation of a trackpad; and

FIGS. 4A and 4B illustrate an example embodiment of a method for zero-volume trackpad operation.

### DETAILED DESCRIPTION

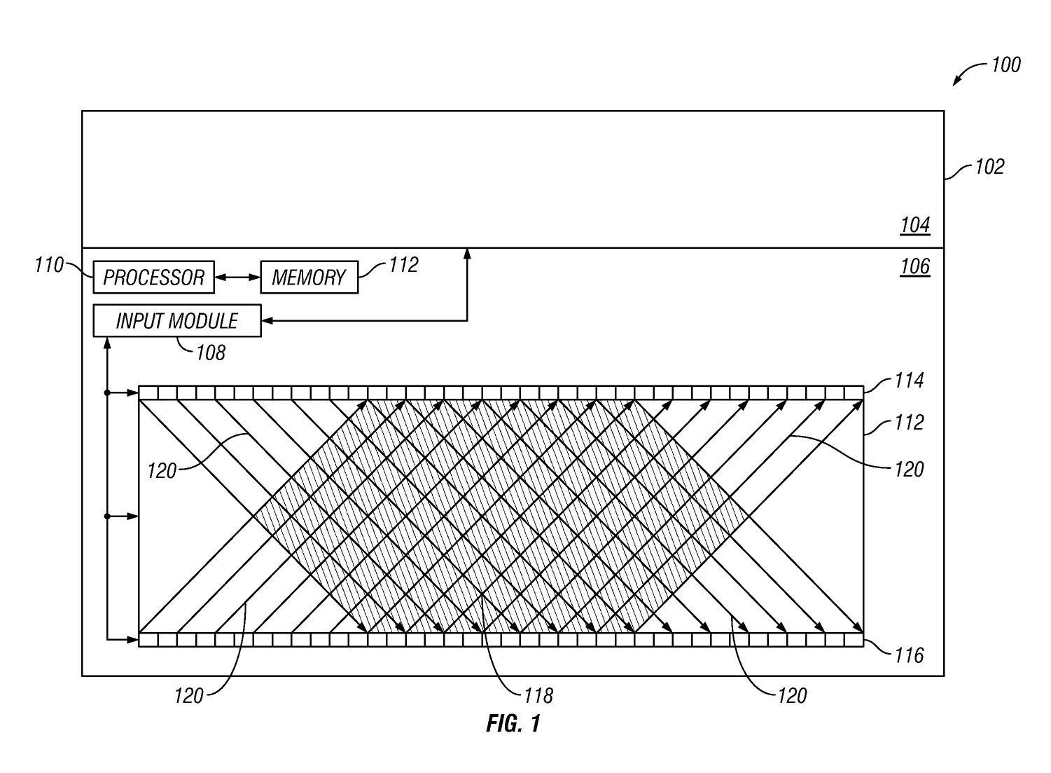

Preferred embodiments and their advantages are best understood by reference to FIGS. 1-4, wherein like numbers are used to indicate like and corresponding parts.

For the purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device, and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media, such as a direct access storage device (e.g., a hard disk drive or floppy disk); a sequential access storage device (e.g., a tape disk drive); a compact disk; CD-ROM; DVD; random access memory (RAM); read-only memory (ROM); electrically erasable programmable read-only memory (EEPROM); and/or flash memory; as well as communications media, such as wires, optical fibers, microwaves, radio waves, and other electromagnetic and/or optical carriers; and/or any combination of the foregoing.

An information handling system may be configured such that multiple nodes share physical components. A node may include one or more processors configured to run an instance of an operating system. A node may further include a memory and a storage resource. Shared components may include, for example, a system board, power supply, and/or other physical components necessary to process, store, and/or communicate data. In an information handling system configured in this manner, servicing one of the shared components may require that multiple nodes be powered down and/or taken off-line for the duration of the service. For example, each system board may include multiple processors, each of which functions as an individual node. The applications running on each node may experience a disruption in service if the system board is powered off or otherwise taken off-line for service. In accordance with the teachings of the present disclosure, the system state, metadata, and/or system image of each node on a system board requiring service may be captured and transferred or migrated to a target node on other system boards before the system board is powered down for service. By transferring or migrating the operation of the nodes, instead of powering down or otherwise taking the nodes off-line, the disruption in service experienced by the applications running on the nodes may be reduced or eliminated.

FIG. 1 illustrates an example information handling system 100 including a zero-volume trackpad 118, in accordance with the teachings of the present disclosure. The various components of information handling system 100 may be housed in chassis 102, which may fully or partially enclose the components of information handling system 100. Chassis 102 may include information handling resources 104 and zero-volume trackpad subsystem 106.

Information handling resources 104 may include any number or kind of components of an information handling system, such as, for example, storage, processors, memory, display, input devices, display devices, interconnection or networking devices, applications, scripts, code, power supplies, peripherals. Information handling resources 104 may represent a remainder of information handling system 100 to which zero-volume trackpad subsystem 106 is communicatively coupled and for which zero-volume trackpad subsystem 106 is configured to provide input.

Zero-volume trackpad subsystem 106 may be configured to be connected to, communicatively coupled, or otherwise coupled to information handling resources 104 or any other part of information handling system 100 in any suitable manner. For example, zero-volume trackpad subsystem 106 may be integrated within information handling system 100. In another example, zero-volume trackpad subsystem 106 may be connected to information handling resources 104 through wireless, Universal Serial Bus, network, Ethernet, or any other suitable bus or information transport mechanism. Zero-volume trackpad subsystem 106 may be configured to provide input to information handling system 100 upon detection of such input as described below.

Zero-volume trackpad subsystem 106 may include any suitable number or kind of components for providing input to information handling system 100 through zero-volume trackpad 118. For example, zero-volume trackpad subsystem 106 may include a processor 110 communicatively coupled to a memory 112. Processor 110 may be configured to execute instructions in memory 112 for supporting use of zero-volume trackpad 118. In another example, zero-volume trackpad subsystem 106 may include an input module 108. Input module 108 may be configured to support use of zero-volume trackpad 118. Input module 108 may be implemented in any suitable manner, such as with a processor, analog circuitry, digital circuitry, software, code, instructions, libraries, scripts, executables, object code, applications, or any combination thereof. Input module 108 may include instructions or logic on memory 112 for execution by processor 110 that, when executed, may cause the operation of input module 108 as described herein.

Processor 110 may include any system, device, or apparatus operable to interpret and/or execute program instructions and/or process data, and may include without limitation a microprocessor, microcontroller, digital signal processor (DSP), application specific integrated circuit (ASIC), or any other digital or analog circuitry configured to interpret and/or execute program instructions and/or process data. In some embodiments, the processor may interpret and/or execute program instructions and/or process data stored in memory 112 and/or another component of information handling system 100. Memory 112 may include any instrumentality or aggregation of instrumentalities that may retain data and/or instructions for a period of time. Memory 112 may include random access memory (RAM), electrically erasable programmable read-only memory (EEPROM), a Personal Computer Memory Card International Association (PCMCIA) card, flash memory, solid state disks, hard disk drives, magnetic tape libraries, optical disk drives, magneto-optical disk drives, compact disk drives, compact disk arrays, disk array controllers, and/or any suitable selection or array of volatile or non-volatile memory operable to store data.

Input module 108 may be configured to determine or translate inputs into zero-volume trackpad 118. Input module 108 may be communicatively coupled to any suitable mechanisms for determining the inputs into zero-volume trackpad 118. For example, input module 108 may be communicatively coupled to one or more sensor arrays, such as sensor arrays 114, 116.

Information handling system 100 may include any suitable number, kind, or arrangement of sensor arrays to form zero-volume trackpad 118. In one embodiment, such sensor arrays may include infrared (IR) arrays. In another embodiment, such sensor arrays may include optical arrays. In yet another embodiment, such sensor array may include capacitive sensors, wherein intrusion of a finger into a plane may cause a change in capacitance of one or more electrical devices. In still yet another embodiment, sensor arrays may be arranged in an X-Y coordinate plane. Such an arrangement may include perpendicular sensor arrays or parallel sensor arrays. In another embodiment, sensor arrays may be arranged in three dimensions. For example, sensor arrays 114, 116 may each include a plurality of vertically stacked sensors.

In the example of FIG. 1, which is provided for example and illustrative purposes only, zero-volume trackpad subsystem 106 may include an IR optical sensor array 114 in parallel with another optical sensor array 116. Sensor arrays 114, 116 may include transmitters and receivers. Sensor arrays 114, 116 may be configured to sense a vertical aspect of use of zero-volume trackpad 118.

Sensor arrays may be configured to provide data in any suitable manner. In the example of FIG. 1, sensor arrays 114, 116 may be configured to detect transmission of information source from the other of sensor arrays 114, 116 and, consequently, to detect when something is blocking such a source. Sensor arrays 114, 116 may be configured to send and detect data at angles, off-center, or non-orthogonally to a reference grid. Accordingly, given an interruption at a pixel between sensor arrays 114, 116, the location of the interruption may be determined by referencing which of sensor array 114 determined an interruption, which of sensor array 116 determined an interruption, and triangulating a location based on the knowledge of the angles at which sensor arrays 114, 116 transmit and receive.

Sensor arrays 114, 116 may be configured to provide information about sent, received, detected, and blocked information to input module 108. Input module 108 may be configured to perform the triangulation and location determinations of any interruptions into the field generated by sensor arrays 114, 116.

The operation and positioning of sensor arrays 114, 116 may yield an area for which detection may be made. Such an area may include zero-volume trackpad 118. As shown in FIG. 1, zero-volume trackpad 118 may include areas in which sensor array 114, 116 may adequately track anything occurring between such sensor arrays.

Zero-volume trackpad 118 may be applied to any suitable portion of information handling system 100. In one embodiment, zero-volume trackpad 118 may be formed over a keyboard area 112. Keyboard area 112 may include a fixed keyboard area, such as that on a tablet, laptop, or smartphone. Keyboard area 112 may include a traditional QWERTY-style keyboard layout, or any other suitable layout. Furthermore, keyboard area 112 may include some or all of a physical keyboard, or some or all of a virtual or generated keyboard.

Zero-volume trackpad 118 may be configured for a user of information handling system 100 to use a trackpad in the space above, for example, keyboard area 112. Such a trackpad may require no touching and may be manipulated in the air. The operation of zero-volume trackpad 118 may be made to emulate use of, for example, physical trackpad, touch-screen, mouse, pointer, or joystick input. Upon determination of use of zero-volume trackpad 118, input module 108 may be interpret the signals received from sensor arrays 114, 116 and specify input to information handling system 100.

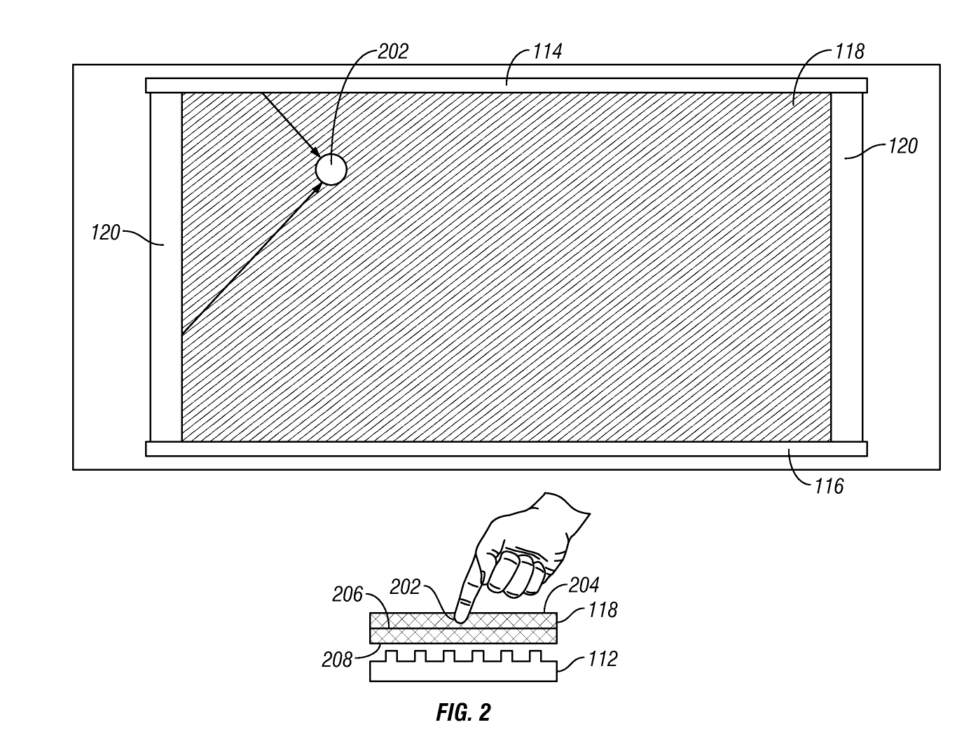

FIG. 2 illustrates an example operation of zero-volume trackpad 118. A user may make an input 202 into zero-volume trackpad 118 with a finger. Sensor arrays 114, 116 may detect the presence of input 202. Furthermore, given not only the position but the size of input 202, input module 108 may interpret the input as initiation of use of zero-volume trackpad 118. The top-view of FIG. 2 illustrates that the X-Y coordinates and size of input 202 may be detected by triangulation of sensor arrays 114, 116. The size of input 202 may be determined by, for example, determination of the number of sensors which have detected input 202. Furthermore, the side-view of FIG. 2 illustrates that input 202 may break a plane of operation of zero-volume trackpad 118. While zero-volume trackpad 118 is shown with a thickness in the side-view, such a thickness is shown for illustrative purposes only.

Given a detection of input 202, input module 108 may determine whether input 202 is intended, for example, as operation of zero-volume trackpad 118 or is an attempt to, for example, operate keyboard area 112. Any suitable manner or mechanism of such a determination may be used by input module 108.

Operation of zero-volume trackpad 118 may be activated by, for example, a physical or virtual toggle button or other option within information handling system 100. By turning zero-volume trackpad 118 on or off, a user of information handling system 100 may more accurately use zero-volume trackpad 118 in combination with other elements, such as keyboard area 112.

Several dead-spots 120 may be included within zero-volume trackpad subsystem 106. Such dead-spots 120 may include areas accessible by one or more portions of sensor arrays 114, 116, but are only partially covered by the arrangement of such sensors. In dead-spots 120, detection of precise position or size may not be possible. However, the presence of an input 202 may yet be determined in dead-spots 120 through, for example, blocking of signals into a single one of sensory array 114 or sensor array 116. Input 202 into such dead-spots 120 may be determined by input module 108 to be access of keyboard area 112 rather than zero-volume trackpad 118.

In one embodiment, input module 108 may be configured to analyze signals from sensor arrays 114, 116 to determine, based upon time, whether a user is intending to touch keyboard area 112 or to use zero-volume trackpad 118. In a further embodiment, input module 108 may make such a determination by, for example, using hysteresis or a delay. Given input 202, input module 108 may be configured to wait for an additional period of time, such as fifty milliseconds. If no input from keyboard area 112 is detected within such a period of time after input 202 is detected into zero-volume trackpad 118, input module 106 may be configured to determine that a user intends access of zero-volume trackpad 118. Subsequently, tracking of the use of input into zero-volume trackpad 118 may be monitored and sent to information handling system 100 as input. If input from keyboard area 112 is detected within such a period of time after input 202 into zero-volume trackpad 118, input module 106 may be configured to determine that a user intends access of keyboard 112 rather than zero-volume trackpad 118. Accordingly, input module 108 may wait for the time period to expire before translating input into zero-volume trackpad 118. After such a time period, it may be determine that, for example, a user is hovering above keyboard area 112 and using zero-volume trackpad 118.

In another, further embodiment, input module 108 may determine whether a user is intending to touch keyboard area 112 or to use zero-volume trackpad 118 by estimating the velocity of a user's finger or fingers as the finger approaches zero-volume trackpad 118 and keyboard area 112. Given input 202, input module 108 may be configured to determine a velocity of the input 202. Such velocity may be measured in terms of vertical velocity.

Velocity may be detected by, for example, determining how fast various levels of sensors 114, 116 are blocked. In another example, velocity may be detected by establishing a rate of change of light blocking through a layer of approaches zero-volume trackpad 118. If, for example, sensors 114, 116 are implemented through capacitance sensors, velocity may be determined by a rate of change of the resultant field strength as input 202 is made. In each such case, a relationship may be established between the rate of change of various signals and resultant velocity. Furthermore, acceleration and deceleration may be determined from observation of velocity, given that the rate of change of the velocity may yield such acceleration.

The side-view of FIG. 2 illustrates that as input 202 is made, input module 106 may determine a first vertical position 204 of input 202, and whether input 202 has reached a second vertical position 206 or a third vertical position 208. From such determinations, in combination with timing of such observations, input module 106 may determine velocity and acceleration.

Various thresholds for velocity and acceleration may be established according to observation of typical use of zero-volume trackpad 118. Such thresholds may be used to determine how to handle input 202 given different velocities. For example, given a “fast” threshold, wherein input 202 is made with velocity over, for example, one centimeter per second, input module 106 may be configured to determine that a user intends access of keyboard area 112 rather than zero-volume trackpad 118. Such a situation may illustrate input 202 wherein a user is quickly reaching for keyboard area 112. Such a “fast” threshold may be combined with a determination that no deceleration is observed during an approach of input 202 to keyboard area 112, such that input module 106 determines that a user intends access of keyboard area 112 rather than zero-volume trackpad 118. In another example, such a “fast” threshold in combination with a determination that deceleration is observed during an approach may cause input module 106 to determine that a user intends access of zero-volume trackpad 118 rather than keyboard area 112. In yet another example, using a “slow” threshold—wherein input 202 is made with velocity under, for example, half-a-centimeter per second—input module 106 may determine that a user intends access of keyboard area 112 rather than zero-volume trackpad 118. Such an example may illustrate a case of a user intending to rest fingers upon keyboard area 112. However, observation of such velocity under such a “slow” threshold in combination with lateral X-Y movement may cause input module 106 to determine that a user intends access of zero-volume trackpad 118 rather than keyboard area 112. Such an example may illustrate a case of a user searching for a mouse pointer of zero-volume trackpad 118. In additional cases, a velocity and acceleration of input 202 may match no definitive use case of preference for zero-volume trackpad 118 input or keyboard area 112 input. In such cases, input module 106 may determine user input according to, for example, the delay described above.

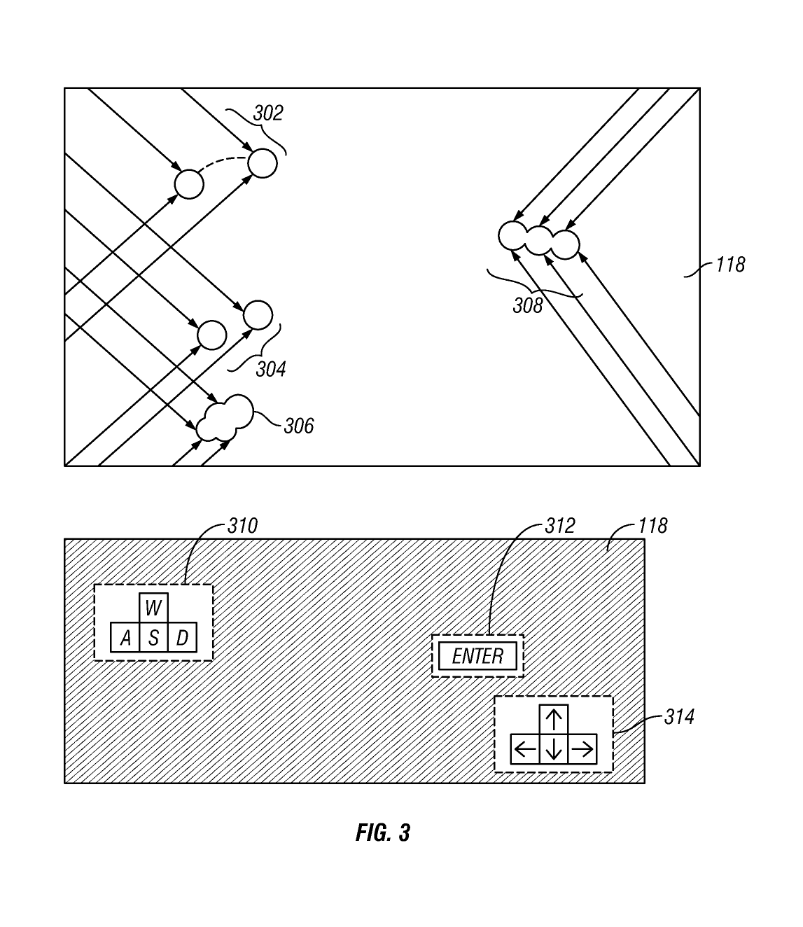

FIG. 3 illustrates additional operation of zero-volume trackpad 118 as interpreted by input module 108.

Input 302 may illustrate a detected input to zero-volume trackpad 118 that has subsequently moved positions. Such input 302 may indicate, for example, a user that has placed a finger into zero-volume trackpad 118 and is attempting to wiggle or circle a finger to locate a pointer in a display of information handling system 100. Such an input from a user may be an attempt by the user to take control of a pointer through zero-volume trackpad 118. Input module 108 may be configured to determine such movement immediately upon input into zero-volume trackpad 118. Based upon an input into zero-volume trackpad 118 followed by immediate movement, which may be in a semi-circular fashion, input module 108 may be configured to determine that such an input is to be applied to zero-volume trackpad 118 as opposed to, for example, keyboard area 112. Consequently, input module 108 may be configured to short-circuit an otherwise used delay or hysteresis period.

Input 304 may illustrate a determination of multiple finger input. Input 304 may identify multiple independent inputs. Furthermore, input 306 may illustrate a determination of multiple finger input. Input 306 may identify a single input of such shape or size as to indicate multiple finger input. Detection of blocked signals or the presence of such input through input arrays 114, 116 may yield a determination of input 304 or input 306. Input 304 and input 306 may indicate that multiple fingers are resting upon keyboard area 112. Input module 106 may be configured to, upon determination of multiple fingers resting upon keyboard area 112, determine that a user intends to use keyboard area 112 rather than zero-volume trackpad 118.

In one embodiment, input module 106 may be configured to determine whether a user prefers left- or right-handed operation. Such a determination may be made by, for example, user preferences in information handling system 100 or observation of which side of zero-volume trackpad 118 typically receives an initial one-finger input. Based upon such a determination of preferred left- or right-handed operation, input module 106 may be configured to further interpret multiple finger inputs.

For example, given a preference for right-handed operation, multiple-finger input on the left side of zero-volume trackpad 118 may be ignored or otherwise presumed to be intended for use of keyboard area 112. However, multiple finger input, such as input 308, in the right side of zero-volume trackpad 118 may be monitored for movement before classifying input 308 as intended for keyboard area 112. Upon detection of movement of input 308 in the right side of zero-volume trackpad 118 given a preference for right-handed operation, input module 108 may be configured to treat input 308 as input into zero-volume trackpad 118. Such handling may be made despite the fact that input 308 includes multiple-finger input.

In one embodiment, an area of keyboard area 112 as overlaid by zero-volume trackpad 118 may be designated as a reserved area. Such areas may include buttons or options of keyboard area 112 that will encounter frequent use. The frequent use may depend upon a particular mode of operation of information handling system 100, such as when particular applications are used on information handling system 100. Given a reserved area, input module 108 may be configured to ignore input into zero-volume trackpad 118 into such a reserved area and presume that such input is intended for the corresponding portions of keyboard area 112. Input module 108 may be configured to determine a user preference, application setting, currently active application, or other indication in information handling system 100 to toggle a given reserved area on or off. User preferences may allow toggling of a given reserved area by input from a user. Furthermore, a currently active application may be a highlighted, frontally-presented, or active window of an application on information handling system. Such an active window or application may be selected among a plurality of open windows or applications presently execution on an information handling system.

For example, gaming applications may make extensive use of the keys “W”, “A”, “S”, and “D” as a proxy for up, left, down, and right commands. Accordingly, information handling system 100 may include an option to signal to input module 108 to ignore all zero-volume trackpad 118 inputs into region 310. In another example, use of the “Enter” key may be often used, even when use of zero-volume trackpad 118 is made. Accordingly, input module 108 may ignore all zero-volume trackpad 118 inputs into region 312. In yet another example, input module 108 may ignore all zero-volume trackpad 118 inputs to arrow keys in region 314.

In one embodiment, one side of zero-volume trackpad 118 may be designated for input into such zero-volume trackpad 118 (for mouse, pointer, or similar operations) and another side of zero-volume trackpad 118 may be designated for typical keyboard input. Such arrangements may allow one hand of a user to be used for trackpad operations and the other hand of the user to be used for keyboard operations. Thus, input module 108 may be configured to ignore one designated side of zero-volume trackpad 118 and presume that all such inputs are intended for keyboard area 112, and to accept all inputs into the other side of zero-volume trackpad 118 as trackpad operations.

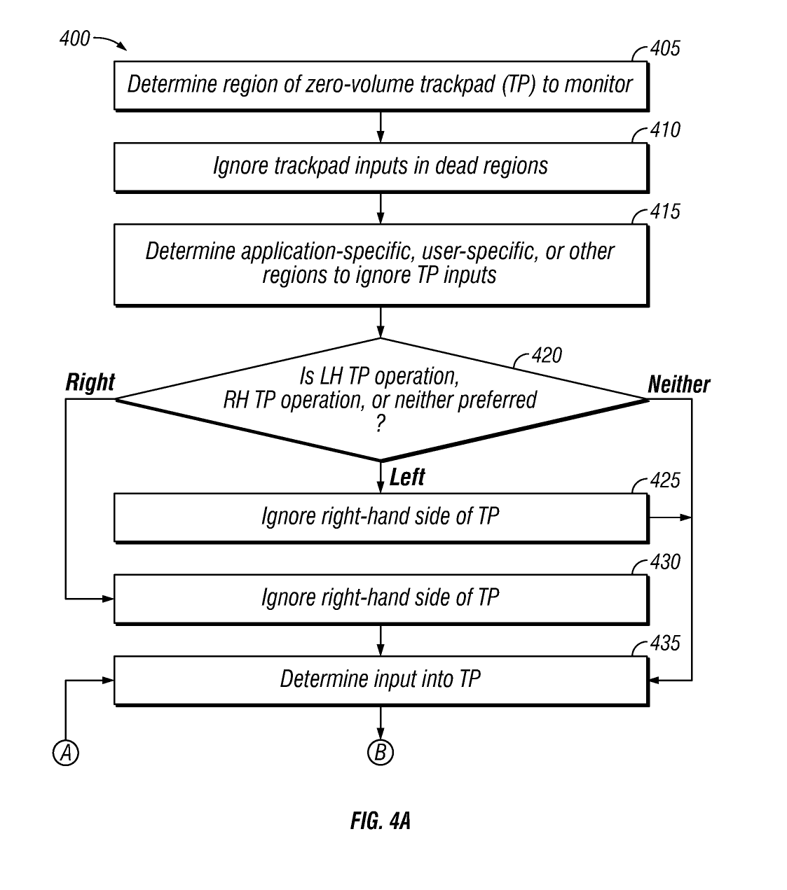

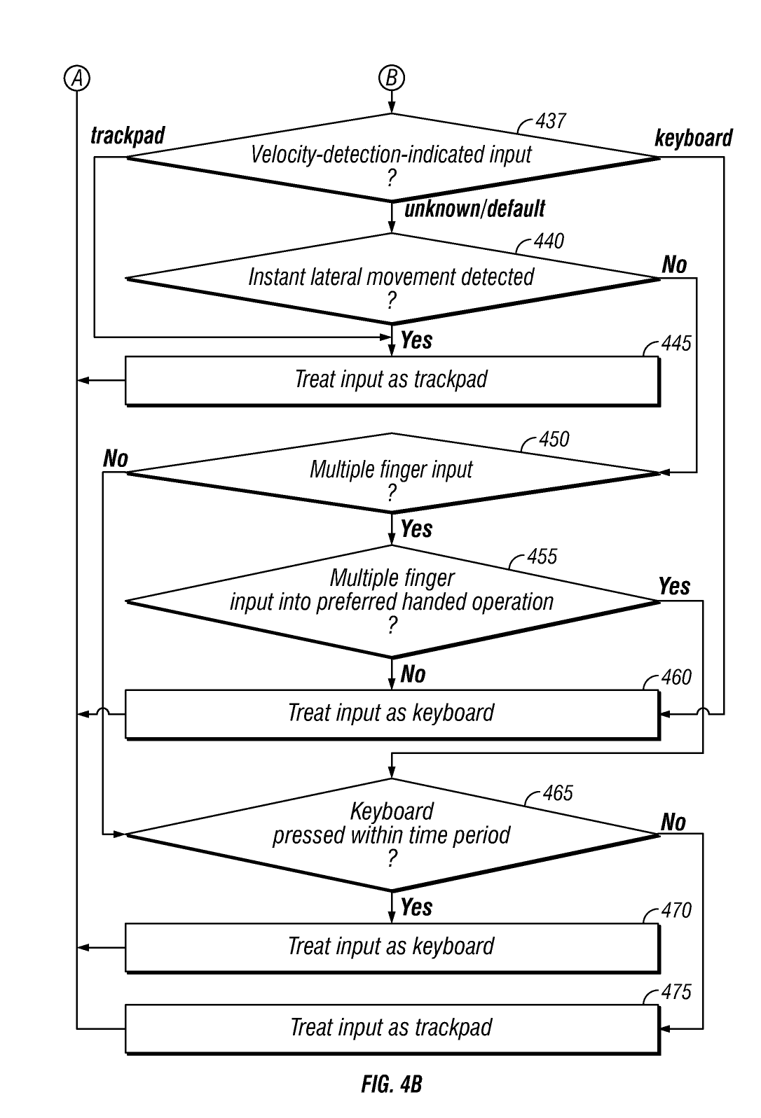

FIGS. 4A and 4B illustrate an embodiment of an example method 400 for zero-volume trackpad operation. At 405, a region of a zero-volume trackpad may be determined. Such a region may be monitored for input into an information handling system. The zero-volume trackpad may overlay a keyboard or a keyboard area. The zero-volume trackpad may be formed by one or more arrays of sensors.

At 410, dead regions associated with the sensor arrays may be configured to be ignored with respect to zero-volume trackpad input. Such regions may include portions of the information handling system in which the precise location, shape, or number of fingers for zero-volume trackpad input may not be accurately determined.

At 415, one or more regions to be ignored with respect to zero-volume trackpad input may be determined. Such regions may include, for example, regions over specific keys of the keyboard area. The specific keys over which input to the zero-volume trackpad will be ignored may depend upon a user configuration, an active application, or other settings that may be specific to a particular user, time, or application. The ability to ignore such input may be toggled and reevaluated during execution of method 400.

At 420, it may be determined whether left-hand operation of the zero-volume trackpad, right-hand operation of the zero-volume trackpad, or neither is preferred. Such a preference may be determined according to, for example, user preferences. Such a preference may indicate that if one portion of the zero-volume trackpad is intended to be used as a trackpad, while another portion of the zero-volume trackpad is intended to be ignored with respect to trackpad input. Such an ignored region may be used, for example, for keyboard input. If left-hand operation is preferred, method 400 may proceed to 425. If right-hand operation is preferred, method 400 may proceed to 430. If neither is preferred, method 400 may proceed to 435.

At 425, a right-hand side of the zero-volume trackpad may be ignored. Method 400 may proceed to 435. At 430, a left-hand side of the zero-volume trackpad may be ignored. Method 400 may proceed to 435.

At 435, the zero-volume trackpad may be monitored and input into the zero-volume trackpad may be determined or detected. Such an input may include a portion of the zero-volume trackpad that has not been ignored. Subsequently, handling of the input may be determined.

At 437, it may be determine whether any input has been detected that indicates an associated velocity or acceleration detection. Such a velocity detection may be made by measuring the time at which various vertical positions are detected, or by a change in associated electrical or magnetic properties. An acceleration detection may be made by observing a change in velocity. The velocity and acceleration detections may be used to determine how to handle the input. If, based upon velocity or acceleration detection, an input is to be handled as an attempt by a user to use a keyboard, then method 400 may proceed to 460. If, based upon velocity or acceleration detection, an input is to be handled as an attempt by a user to use a trackpad, then method 400 may proceed to 445. If a velocity or acceleration detection has not been made, or if a detection has been made for which a definitive determination of user input cannot be deduced, then method 400 may proceed to 440.

At 440, it may be determined whether, subsequent to the input into the zero-volume trackpad, an instant or nearly instant lateral movement is detected. Such input may include, for example, circular movement of input into zero-volume trackpad. The input may represent an attempt by a user to acquire a mouse or other pointer in association with the zero-volume trackpad. If such subsequent movement is detected, method 400 may proceed to 445. If such subsequent movement is not detected, method 400 may proceed to 450 to continue processing of the input.

At 445, the detected input may be treated as trackpad input. The measurements, data, or other information associated with the input may be sent to the information handling system as trackpad input. Method 400 may proceed to 435.

At 450, it may be determined whether the input includes multiple fingers. In one embodiment, 450 may use a threshold of two fingers. In another embodiment, 450 may use a threshold of three or more fingers. If multiple finger input is detected, method 400 may proceed to 455. If multiple finger input is not detected in association with the detected input to zero-volume trackpad, method 400 may proceed to 465.

At 455, it may be determined whether the multiple finger input is into a preferred-handed operation. Such a preference may have been determined, for example, in 420. Given a preference for left-handed or right-handed trackpad operation, multiple-finger operation may be allowed for zero-volume trackpad input into such a preferred portion. If the multiple finger input is into a preferred-handed operation, method 400 may proceed to 460. If the multiple finger input is not into a preferred-handed operation, method 400 may proceed to 465.

At 460, the detected input may be ignored as trackpad input or handled as keyboard input. The measurements, data, or other information associated with the input through the sensors may be ignored. Method 400 may proceed to 435.

At 465, it may be determined whether, subsequent to the detection of zero-volume trackpad input, the keyboard or keyboard area has been pressed within a time period. The time period may include, for example, fifty milliseconds. 465 may thus provide hysteresis detection. If such a keyboard has been pressed within the time period, method 400 may proceed to 470. If such a keyboard has not been pressed within the time period, method 400 may proceed to 475.

At 470, the detected input may be ignored as trackpad input or handled as keyboard input. The measurements, data, or other information associated with the input through the sensors may be ignored. Method 400 may proceed to 435.

At 475, the detected input may be treated as trackpad input. The measurements, data, or other information associated with the input may be sent to the information handling system as trackpad input. Method 400 may proceed to 435.

Although FIG. 4 discloses a particular number of steps to be taken with respect to example method 400, method 400 may be executed with more or fewer steps than those depicted in FIG. 4. In addition, although FIG. 4 discloses a certain order of steps to be taken with respect to method 400, the steps comprising method 400 may be completed in any suitable order. Method 400 may be implemented using the system of FIGS. 1-3 or any other system, network, or device operable to implement method 400. In certain embodiments, method 400 and 900 may be implemented partially or fully in software embodied in computer-readable media.

Although the present disclosure has been described in detail, it should be understood that various changes, substitutions, and alterations can be made hereto without departing from the spirit and the scope of the disclosure as defined by the appended claims.

What is claimed is:

1. A method of determining user input into an information handling system, comprising:
determining a region of a zero-volume trackpad overlaying a keyboard area;
detecting an access of the zero-volume trackpad;
determining whether to interpret the access as input into the zero-volume trackpad based upon timing of the input.

2. The method of claim 1, wherein the timing of the input includes a time delay associated with the input and any subsequent access of the keyboard area.

3. The method of claim 2, further comprising determining that the access is not input into the zero-volume trackpad based upon a subsequent detected access of the keyboard area within the time delay.

4. The method of claim 2, further comprising determining that the access is input into the zero-volume trackpad based upon expiration of the time delay without a subsequent detection of access of the keyboard area.

5. The method of claim 1, further comprising interpreting the access as input into the zero-volume trackpad based upon a detection of subsequent access of the zero-volume trackpad, wherein the access and subsequent access are laterally located from each other.

6. The method of claim 1, further comprising ignoring input into a portion of the zero-volume trackpad, the portion corresponding to one or more identified keys of the keyboard area.

7. The method of claim 6, wherein the portion of the zero-volume trackpad is selected based upon a selection of an application from a plurality of applications executing on the information handling system.

8. The method of claim 1, further comprising:
determining whether the access is made by multiple fingers; and
interpreting the access as input into the zero-volume trackpad based the determination of whether the access is made by multiple fingers.

9. The method of claim 1, wherein the timing of the input includes a determination of a velocity of the input.

10. The method of claim 1, further comprising ignoring input into a portion of the zero-volume trackpad, the portion corresponding to one or more portions of the keyboard area above which a determination of the input is incomplete.

11. An information handling system, comprising:
a sensor array configured to detect an access to a zero-volume trackpad, the zero-volume trackpad overlaying a keyboard area;
an input module communicatively coupled to the sensor array and configured to determine whether to interpret the access as input into the zero-volume trackpad based upon timing of the input.

12. The information handling system of claim 11, wherein the timing of the input includes a time delay associated with the input and any subsequent access of the keyboard area.

13. The information handling system of claim 12, wherein:
the sensor array is configured to detect a subsequent access of the keyboard area within the time delay; and
the input module is further configured to determine that the access is not input into the zero-volume trackpad based upon the detection of the subsequent access within the time delay.

14. The information handling system of claim 12, wherein the input module is further configured to determine that the access is input into the zero-volume trackpad based upon expiration of the time delay without a subsequent detection of access of the keyboard area.

15. The information handling system of claim 11, wherein the input module is further configured to interpret the access as input into the zero-volume trackpad based upon a detection of subsequent access of the zero-volume trackpad, wherein the access and subsequent access are laterally located from each other.

16. The information handling system of claim 11, wherein the input module is further configured to ignore input into a portion of the zero-volume trackpad, the portion corresponding to one or more identified keys of the keyboard area.

17. The information handling system of claim 16, wherein the portion of the zero-volume trackpad is selected based upon a selection of an application from a plurality of applications executing on the information handling system.

18. The information handling system of claim 11, wherein the input module is further configured to:
determine whether the access is made by multiple fingers; and
interpret the access as input into the zero-volume trackpad based the determination of whether the access is made by multiple fingers.

19. The information handling system of claim 11, wherein the timing of the input includes a determination of a velocity of the input.

20. The information handling system of claim 11, wherein the input module is further configured to ignore input into a portion of the zero-volume trackpad, the portion corresponding to one or more portions of the keyboard area above which a determination of the input is incomplete.

21. A non-transitory computer-readable medium including computer-executable instructions encoded in the computer-readable medium, the instructions, when executed by a processor, operable to perform operations comprising:
determining a region of a zero-volume trackpad overlaying a keyboard area;
detecting an access of the zero-volume trackpad;
determining whether to interpret the access as input into the zero-volume trackpad based upon timing of the input.

22. The medium of claim 21, wherein the timing of the input includes a time delay associated with the input and any subsequent access of the keyboard area.

23. The medium of claim 22, further comprising instructions operable to determine that the access is not input into the zero-volume trackpad based upon a subsequent detected access of the keyboard area within the time delay.

24. The medium of claim 22, further comprising instructions operable to determine that the access is input into the zero-volume trackpad based upon expiration of the time delay without a subsequent detection of access of the keyboard area.

25. The medium of claim 21 further comprising instructions operable to interpret the access as input into the zero-volume trackpad based upon a detection of subsequent access of the zero-volume trackpad, wherein the access and subsequent access are laterally located from each other.

26. The medium of claim 21, further comprising instructions operable to ignore input into a portion of the zero-volume trackpad, the portion corresponding to one or more identified keys of the keyboard area.

27. The medium of claim 26, wherein the portion of the zero-volume trackpad is selected based upon a selection of an application from a plurality of applications executing on the information handling system.

28. The medium of claim 21, further comprising instructions operable to:
determine whether the access is made by multiple fingers; and
interpret the access as input into the zero-volume trackpad based the determination of whether the access is made by multiple fingers.

29. The medium of claim 21, wherein the timing of the input includes a determination of a velocity of the input.

30. The medium of claim 21, further comprising instructions operable to ignore input into a portion of the zero-volume trackpad, the portion corresponding to one or more portions of the keyboard area above which a determination of the input is incomplete.
